(19) United States
(12) Patent Application Publication
(10) Pub. No.: US 2024/0005215 A1
(43) Pub. Date: Jan. 4, 2024

(54) TRAINING MODELS FOR FEDERATED LEARNING

(71) Applicant: INTERNATIONAL BUSINESS MACHINES CORPORATION, ARMONK, NY (US)

(72) Inventors: Yuya Jeremy Ong, San Jose, CA (US); Yi Zhou, San Jose, CA (US); Nathalie Baracaldo Angel, San Jose, CA (US)

(21) Appl. No.: 17/809,826

(22) Filed: Jun. 29, 2022

(51) Int. Cl. G06N 20/20

(52) U.S. Cl. CPC G06N 20/20

(57) ABSTRACT

A method, system, and computer program product for training models for federated learning. The method determines, by a federated learning aggregator, a set of sample ratios for a set of participant systems. Each sample ratio is associated with a distinct participant system. A set of participant epsilon values are generated for the set of participant systems with each participant epsilon value being associated with a participant system of the set of participant systems. A set of surrogate data sets are received for the set of participant systems with each surrogate data set representing a data set of a participant system. The federated learning aggregator generates a set of local models. Each local model is generated based on a first global model. The method generates a second global model based on a prediction set generated by the set of participant systems using the set of local models.

### BACKGROUND

Federated learning enables training of machine learning models across systems, while maintaining data in disparate locations. Federated learning can build AI models with data by combining outputs across different applications and cloud computing systems.

### SUMMARY

According to an embodiment described herein, a computer-implemented method for training models for federated learning is provided. The method determines, by a federated learning aggregator, a set of sample ratios for a set of participant systems. Each sample ratio is associated with a distinct participant system. A set of participant epsilon values are generated for the set of participant systems with each participant epsilon value being associated with a participant system of the set of participant systems. A set of surrogate data sets are received for the set of participant systems with each surrogate data set representing a data set of a participant system. The federated learning aggregator generates a set of local models. Each local model is generated based on a first global model. The method generates a second global model based on a prediction set generated by the set of participant systems using the set of local models.

According to an embodiment described herein, a system for training models for federated learning is provided. The system includes one or more processors and a computer-readable storage medium, coupled to the one or more processors, storing program instructions that, when executed by the one or more processors, cause the one or more processors to perform operations. The operations determine, by a federated learning aggregator, a set of sample ratios for a set of participant systems. Each sample ratio is associated with a distinct participant system. A set of participant epsilon values are generated for the set of participant systems with each participant epsilon value being associated with a participant system of the set of participant systems. A set of surrogate data sets are received for the set of participant systems with each surrogate data set representing a data set of a participant system. The federated learning aggregator generates a set of local models. Each local model is generated based on a first global model. The operations generate a second global model based on a prediction set generated by the set of participant systems using the set of local models.

According to an embodiment described herein, a computer program product for training models for federated learning is provided. The computer program product includes a computer-readable storage medium having program instructions embodied therewith, the program instructions being executable by one or more processors to cause the one or more processors to determine, by a federated learning aggregator, a set of sample ratios for a set of participant systems. Each sample ratio is associated with a distinct participant system. A set of participant epsilon values are generated for the set of participant systems with each participant epsilon value being associated with a participant system of the set of participant systems. A set of surrogate data sets are received for the set of participant systems with each surrogate data set representing a data set of a participant system. The federated learning aggregator generates a set of local models. Each local model is generated based on a first global model. The computer program product generates a second global model based on a prediction set generated by the set of participant systems using the set of local models.

### BRIEF DESCRIPTION OF THE DRAWINGS

FIG. 1 depicts a block diagram of a computing environment for implementing concepts and computer-based methods, according to at least one embodiment of the present disclosure.

FIG. 2 depicts a flow diagram of a computer-implemented method for training models for federated learning, according to at least one embodiment of the present disclosure.

FIG. 3 depicts a flow diagram of a computer-implemented method for training models for federated learning, according to at least one embodiment of the present disclosure.

FIG. 4 depicts a flow diagram of a computer-implemented method for training models for federated learning, according to at least one embodiment of the present disclosure.

FIG. 5 depicts a block diagram of a computing system for training models for federated learning, according to at least one embodiment of the present disclosure.

FIG. 6 is a schematic diagram of a cloud computing environment in which concepts of the present disclosure may be implemented, in accordance with an embodiment of the present disclosure.

FIG. 7 is a diagram of model layers of a cloud computing environment in which concepts of the present disclosure may be implemented, in accordance with an embodiment of the present disclosure.

### DETAILED DESCRIPTION

The present disclosure relates generally to methods for training models for federated learning. More particularly, but not exclusively, embodiments of the present disclosure relate to a computer-implemented method for federated machine learning with extreme gradient boosting (XGBoost). The present disclosure relates further to a related system for federated learning, and a computer program product for operating such a system.

Federated learning enables building of artificial intelligence (AI) models or machine learning models across systems, while maintaining data in disparate locations. Federated learning may use disparate data sets by combining outputs across different applications and cloud computing systems. Federated learning presents a solution to enterprise data issues, where moving data across silos is costly, risky, and slow. Duplication of data is expensive in enterprise applications, and data privacy restrictions can prohibit cross border data transfers. Further, federated learning enables building of AI applications and models across different clouds or platforms. Large amounts of data are often useful to effectively generate machine learning models and AI applications. In some instances of federated learning, obtaining relevant data samples can present difficulties. Data generated and owned by different parties may be difficult to utilize without centralized locations, thus preventing creation of relevant machine learning models without federated learning techniques.

Federated learning frameworks may use aggregators to build machine learning models. The aggregator queries parties or participant systems about information useful for learning a predictive model. For example, an aggregator may query (Q) participant systems regarding weights, gradients, sample counts, and other relevant information regarding data sets stored at each distinct participant system. Given a query (Q) from the aggregator, each participant system may compute a reply (R) based on local data (D) or data sets held by the participant system. Each participant system may then transmit a computed reply (R) to the aggregator. Once the replies have been received, the aggregator may fuse results as a single machine learning model (M). Thus, a first participant system may generate a reply of R₁=Q(D₁), a second participant system may generate a reply of R₂=Q(D₂), and an nth participant system may generate a reply of Rₙ=Q(Dₙ). The aggregator may then generate the model (M) as a function of the replies (R₁, R₂, . . . , Rₙ). In this way, federated learning frameworks may retain raw data at each participant system without directly sharing the data and maintaining the data of each participant system at locations or resources relevant to those participant systems.

Gradient boosting is a machine learning technique that produces a prediction model in the form of an ensemble of weak prediction models, typically in the form of decision trees. XGBoost is a decision tree-based ensemble method utilizing a gradient-boosting approach for optimizing against a loss function. Gradient boosting methods may be utilized in various supervised tasks. For example, XGBoost may be used in classification, regression, and ranking based problems. While neural network-based approaches exchange model weights, decision tree-based ensemble methods have previously encountered limitations in exchanging information in federated machine learning systems and aggregators have encountered limitations in fusing tree models.

XGBoost may act as an additive training process. For example, given the following objective function in Equation 1, below, an optimization attempt using XGBoost would entail learning a classification and regressive tree (CART) function via an additive training method in an iterative manner.

$$O b j = {\sum }_{{i = 1}_{}}^{n} l ( {y}_{i} , {\hat{y}}_{i} ) + {\sum }_{K} Ω ( {f}_{k} ) \qquad Equation 1$$

Learning the relevant CART function may define an initial fixed function, learn a new tree to which a previous fixed function is appended, and repeat the process until a criterion is met. The criterion may be any suitable criterion such as a max tree, specified metrics, or other suitable criterion. For example, an aggregator model may be provided as an initial null model. AN additive function may be generated based on a collection of participant queries. Models from previous iterations may be provided by the aggregator and used in an iterative manner. For each leaf in a tree, a split may be added by computing a resulting gain based on the split to find a best feature and value at which to perform the split. However, generation of scores to determine split locations provide difficulties for federated learning systems.

Tree split node finding methods may use approximation algorithms. To support large data sets, a system may propose a candidate set of splits through a set of percentiles of feature distributions. The system may map the continuous features based on these proposed percentiles and aggregate gradient and hessian statistics. The system may then propose a split value using defined formulas. However, such implementations encounter difficulties in determining approximate split candidate points and determining which split candidate point may be bests.

Candidate split points may be found using weighted quantile sketch algorithms. Such systems may utilize percentiles of a feature to capture a distribution of the data evenly across the samples. For example, given [symbol] ₖ={(x₁ₖ, h₁), (x₂ₖ, h₂), . . . , (xₙₖ, hₙ)}, where k is the feature, a ranking function rₖ: [symbol] →[( ), ∞) may be defined as equation 2.

$${r}_{k} ( z ) = \frac{1}{{\sum }_{( x , h ) ∈ {𝒟}_{k}} h} {\sum }_{( x , h ) ∈ {𝒟}_{k} , x < z} h \qquad Equation 2$$

In Equation 2, the function represents a proportion of the feature instance k where the value is smaller than z. The set of candidate split points may be found and defined by {sₖ₁, sₖ₂, . . . , sₖₗ}, such that

$$\vert {r}_{k} ( {s}_{k , j} ) - {r}_{k} ( {s}_{k , j + 1} ) \vert < ϵ ,$$

$${s}_{k 1} = {min}_{i} {x}_{i k} , {s}_{k l} = {max}_{i} {x}_{i k}$$

is satisfied. In such instances, ∈ is a parameter which can dictate the accuracy of the approximation. Thus, 1/∈ number of samples may be obtained. Each data point may be weighted by the hessian h₁. However, federated learning in such systems encounter difficulties due to the aggregator having no information on distribution of each participant system.

Incorporation of gradient tree boosting, such as XGBoost, may present difficulties within federated learning environments. Current implementations can involve training data to determine split candidates. In decision tree learning, trees are built by splitting source data sets, representing root nodes, into subsets of successor children. The XGBoost algorithm sorts training data according to feature values and visits the data in sorted order to accumulate gradient statistics for the structure. Federated learning prevents observation of an entire training data set by a single entity. Thus, an aggregator may be prevented from sorting data and selecting an optimal split candidate of data from participant systems.

Embodiments of the present disclosure enable methods and systems for training XGBoost in federated learning. Such methods and systems maintain accuracy convergence behavior and prevent abnormal loss resulting from incorporation of gradient boosting into an existing federated learning structure. Embodiments of the present disclosure provide improved choice of quantile sketch algorithms implemented to reduce reconstruction error of histograms and improve speed of generating machine learning models. The methods and systems of the present disclosure perform quantile sketch of data as an initial operation to improve machine learning model speed and generation and enabling dynamic party inclusion and exit within the federated learning structure. Embodiments of the present disclosure enable data compression of gradient and hessian data to reduce overall network transfer overhead and increase federated learning stability and performance in creating machine learning models. Embodiments of the present disclosure incorporate XGBoost in horizontal federated learning. Some embodiments of the present disclosure utilize a data fidelity reduction-based approach by binning local data sets to secure raw data of each participant system and overlay differential privacy and encryption methods to enhance security measures for each participant system. Embodiments of the present disclosure provide performance enhancements and enable dynamic party adaptation to accommodate addition or removal of participant systems from the federated learning structure without reducing model quality.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

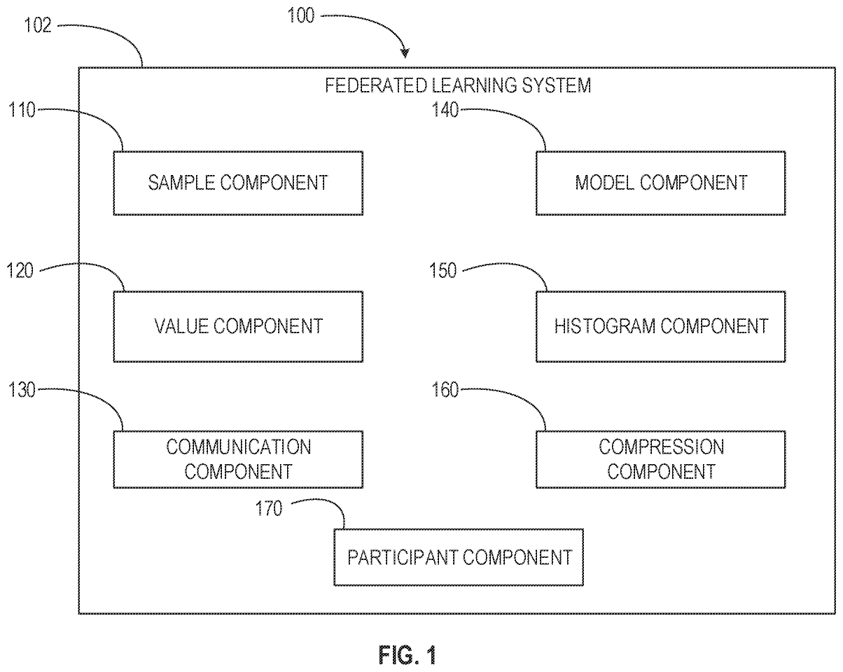

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include a federated learning system 102. The federated learning system 102 may comprise a sample component 110, a value component 120, a communication component 130, model component 140, histogram component 150, compression component 160, and a participant component 170. The sample component 110 handles sample information and generates sample ratios for data sets of participant systems. The value component 120 generates epsilon values for the federated learning system 102 and participant systems. The communication component 130 provides communication functionality between the aggregator and participant systems of the federated learning system 102. The model component 140 generates local models for participant systems and global machine learning models for the federated learning system 102. The histogram component 150 generates surrogate histogram distributions for participant systems and may be implemented on individual participant systems. The compression component 160 provides data compression for data communication between the aggregator and participant systems of the federated learning system 102. The participant component 170 identifies additions and removals of participant systems to the federated learning system 102. Although described with distinct components, it should be understood that, in at least some embodiments, components may be combined or divided, and/or additional components may be added without departing from the scope of the present disclosure.

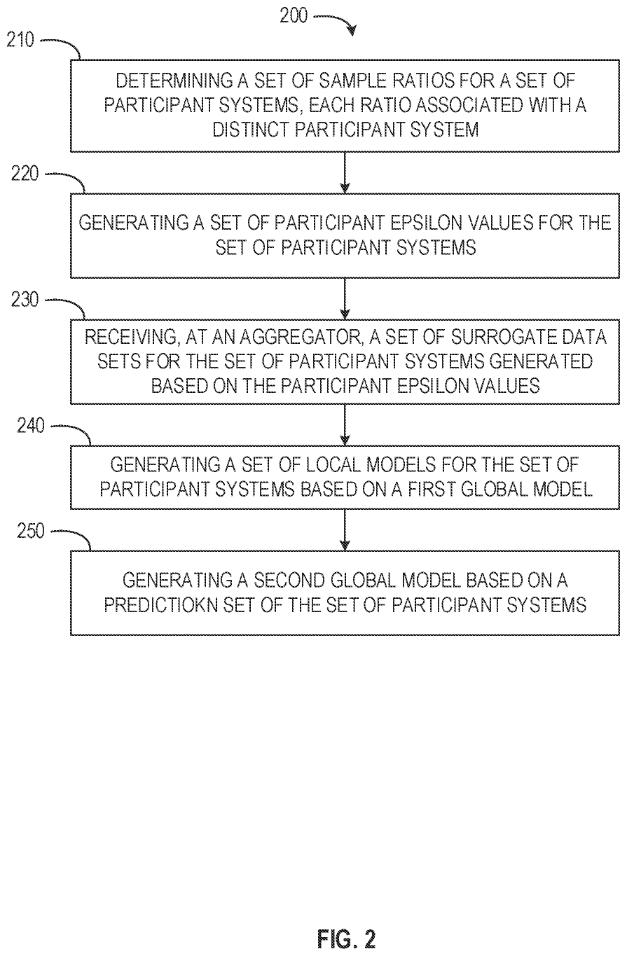

Referring now to FIG. 2, a flow diagram of a computer-implemented method 200 is shown. The computer-implemented method 200 is a method for training models for federated learning. In some embodiments, the computer-implemented method 200 may be performed by one or more components of the computing environment 100, as described in more detail below.

At operation 210, the sample component 110 may determine a set of sample ratios for a set of participant systems. In some embodiments, each sample ratio is associated with a distinct participant system. In some embodiments, the sample component 110 determines a number of samples within a data set of each participant system. The sample component 110 determines a total sample size for the set of participant systems. The sample component 110 may then generate a sample ratio for each participant system based on the total sample size and the number of samples for each participant system.

In some embodiments, the sample component 110 determines the set of sample ratios as an approximate version of the data set globally, across all participant systems. The sample component 110 may initially query each participant system for statistics for deriving approximation parameters and epsilon values.

In some embodiments, the method 200 initiates with an aggregator implementing the sample component 110. The aggregator may initiate the method 200 when the corresponding set of participant systems initialize connections to start a federated learning process.

At operation 220, the value component 120 may generate a set of participant epsilon values for the set of participant systems. In some embodiments, each participant epsilon value is associated with a participant system of the set of participant systems. The participant epsilon value may define a histogram bin size for each participant system. The set of participant epsilon values may be determined by sample sizes of the set of participant systems and a computation of epsilon values per participant system.

In some embodiments, the value component 120 generates the set of participant epsilon values by initially generating or accessing a global epsilon parameter. The global epsilon parameter may be defined as a number of samples to be obtained from all participant systems. For example, global epsilon parameter may be defined as a measure of a total number of samples defined by 1/∈. Given a set of data from each participant system as D={d₁, d₂, . . . , dₙ}, a score of each i-th participant system may be defined by Eqauation 3 below.

$${ϵ}_{i} = ϵ ( \frac{\vert {d}_{i} \vert}{{\sum }_{d ∈ D} \vert d \vert} ) \qquad Equation 3$$

In such instances, the value component 120 may respectively split the epsilon value ∈ with a ratio of the i-th participant system's data size to a total number of data among the set of participant systems. Each participant system may then contribute a defined number of approximated split candidate values represented by Equation 4 below.

$$\frac{1}{{ϵ}_{i}} = \frac{1}{ϵ ( \frac{\vert {d}_{i} \vert}{{\sum }_{d ∈ D} \vert d \vert} )} = \frac{{\sum }_{d ∈ D} \vert d \vert}{ϵ \vert {d}_{i} \vert} \qquad Equation 4$$

The value component 120 generates a participant epsilon value based on the global epsilon parameter and a sample ratio associated with a participant system. In some embodiments, the value component 120 generates a participant epsilon value for each participant system of the set of participant systems, such that each participant system has a participant epsilon value generated based on the global epsilon parameter and a sample ratio associated with that participant system.

The value component 120 may then cooperate with the communication component 130 to transmit the set of participant epsilon values to the set of participant systems. In some embodiments, each participant system receives the participant epsilon value generated based on the sample ratio of that participant system.

In some embodiments, operations 210 and 220 may act as a distributed quantile sketch to generate the approximation. The distributed quantile sketch may be a split value quantile sketch. In some instances, the sample component 110 obtains approximated split value candidates from each participant system. For example, the split value candidates may be obtained as equally spaced percentiles. In some instances, the distributed quantile sketch is a gradient and hessian quantile sketch.

The distributed quantile sketch may be a federated quantile sketch. The federated quantile sketch may entail two components. The first component may be a policy for how the epsilon value is defined between the aggregator and the participant systems. The second component may be a method for collecting surrogate histograms from each participant system and fusing the histograms at the aggregator. The fusion of the histograms may be dependent on the learning task performed (e.g., classification vs. regression).

In some embodiments, the distributed quantile sketch is a distributed data sketch (DDSketch) algorithm. The DDSketch algorithm may present results that are fully mergeable with relative error quantile sketching. Relative error may retain accuracy at a tail end of a distribution. An α-accurate (q₀, q₁) sketch may output quantiles within αx of a value x for all quantiles q, q₀≤q≤q₁. For example, if α=1%, then the error of the quantile sketch will be within 1% of the true value. Basic version of the sketch for a (0, 1) α-accurate sketch would have for each new value be divided into buckets which may be counted based on some defined boundaries to retain a given accuracy range, defined by γ. The accuracy range, defined by γ may be represented as

$$γ : = \frac{( 1 + α )}{( 1 - α )} .$$

In such instances, if α=0.01, then

$$γ = \frac{1.01}{0.99} \approx 1.02 .$$

Given a γ value, the aggregator or a participant system may compute a bin index of a quantile sketch for a value x as i=┌log_{γ}(x)┐. Given the derived i value, the aggregator may append a corresponding value to the appropriate bin index. In some embodiments, DDSketch prevents unbounded growth of values added to a given histogram by imposing a limit on a number of buckets tracked. In some instances, DDSketch may be represented as Algorithm 1 below. DDSketch may relate the error bounds of the sketch, ∈, to a corresponding α used to determine bin size of a histogram. For example, a bin size parameter of 255 may be used.

Algorithm 1

| Input: x ∈ [symbol] _{>0} | |
|---|---|
| i ← ┌log_{γ}(x)┐; | |
| Bᵢ ← Bᵢ + 1; | |
| if \|{j : Bᵢ > 0}\| > m then | |
| \| | i₀ ← min({j : Bⱼ > 0}); |
| \| | i₁ ← min({j : Bⱼ > 0 ∧ j > i₀}); |
| \| | Bᵢ_{₁}← Bᵢ_{₁}+ Bᵢ_{₀}; |
| \| | Bᵢ_{₀}← 0; |

end if

Given a data distribution inserted into a corresponding bin, the aggregator may perform a quantization process to determine a corresponding q-th quantile of the data using Algorithm 2, below.

Algorithm 2

| Input: 0 ≤ q ≤ 1 | |
|---|---|
| i₀ ← min({j : Bⱼ > 0}); | |
| count ← Bᵢ_{₀}; | |
| i ← i₀; | |
| while count ≤ q(n − 1) do | |
| \| | i ← min({j : Bⱼ > 0 ∧ j > i}); |
| \| | count ← count + Bᵢ; |

end while
return 2γⁱ/(γ + 1);

At operation 230, the communication component 130 receives a set of surrogate data sets for the set of participant systems. In some embodiments, each surrogate data set represents a data set of a participant system. The set of surrogate data sets may be a set of histogram distributions generated based on the quantile sketch. Corresponding gradient statistics, based on raw feature values may be aggregated within each surrogate data set for each participant system. The gradient statistics may be aggregated by the defined bin ranges (e.g., add, average, etc.) determined based on the participant epsilon values. In some embodiments, operations 210, 220, and 230 serve as a pre-binning process for the method 200.

In some embodiments, after receiving the set of surrogate data sets as a set of histogram distributions, the aggregator performs a merge operation and combines all the approximated distributions from each of the participant systems. The set of histogram distributions may be combined into a single histogram along with gradient statistics from the participant systems.

Once received, the aggregator may merge the set of surrogate data sets or set of surrogate histograms collected from each participant system. The set of surrogate data sets or histograms may be merged to form a single histogram that can be used with tree functions or tree-based learning, such as XGBoost. In some instances, the set of surrogate data sets may be merged based, at least in part, on the function or learning task to be performed. The aggregator may determine how to combine the set of surrogate data sets based on a smallest or largest resolution (e.g., bin size) of a histogram. For example, classification functions may be better suited to larger bin resolutions, while regression functions may be better suited to smaller bin resolutions.

The aggregator may be supplied the set of surrogate data sets as an ordered list of values which define a threshold of each bin per histogram ranges. An index value may be provided which corresponds to which bin a certain sample falls under. The aggregator may merge or fuse the set of surrogate data sets to generate a fused representation of the set of surrogate data sets by reconstructing surrogate data sets from bin index values and thresholds. The aggregator may compute optimal bin resolution, based on a selected learning task. For example, for classification, the aggregator may compute the optimal bin resolution as a largest bin resolution. For regression, the aggregator may compute the optimal bin resolution as a smallest bin resolution. Given the reconstructed surrogate data set and the optimal bin resolution, the aggregator may construct a merged histogram representation, finding new thresholds and computing new index per sample.

In some embodiments, the aggregator utilizes DDSketch to reconstruct a surrogate representation using Algorithm 3, shown below. The aggregator may reconstruct the surrogate representation given epsilon as defined by a given epsilon value or global epsilon value.

Algorithm 3

```
Input: X ∈ [symbol]   ⁿ
\tilde{X}=Ø
for each x ∈ X:
  p← ptile(x, X)
  \tilde{X} ← \tilde{X} ∪ Quantile(p)
end
```

In some embodiments, the aggregator may merge the set of surrogate data sets using the DDSketch algorithm. For example, given two sets of sketches, S and S′, the aggregator performs a merge operation of histograms using Algorithm 4, shown below.

Algorithm 4

| Input: DDSketch S′ | |
|---|---|
| foreach i : Bᵢ > 0 ∨ B′ᵢ > 0 do | |
| \| | Bᵢ ← Bᵢ + B′ᵢ; |
| end foreach | |
| while \|{j : Bⱼ > 0}\| > m do | |
| \| | i₀ ← min({j : Bⱼ > 0}); |
| \| | i₁ ← min({j : Bⱼ > 0 ∧ j > i₀}); |
| \| | Bᵢ_{₁}← Bᵢ_{₁}+ Bᵢ_{₀}; |
| \| | Bᵢ_{₀}← 0; |

end while

The merge operation for the set of surrogate data sets may generally involve two steps. First, the aggregator may merge together corresponding bins from two sketches. Second, the aggregator collapses the buckets based on the smallest index to ensure that the sketch stays within a given limit.

In some instances, the aggregator collect's the gradients and hessian values from the set of participants and aggregates the histograms of the participant systems by decompressing transmissions from the set of participant systems. Once the gradients and hessian values are decompressed, the aggregator determines a quorum has been established given a subset of the participant systems providing gradients and hessian values. The histograms of the subset of participant systems are merged into a single histogram representation. Given the data of the single histogram representation, the aggregator maps the value threshold, gradient, and hessian values for each sample collected using the merged histograms.

At operation 240, the model component 140 generates a set of local models. In some embodiments, each local model is generated based on a first global model. The first global model may be initialized as an aggregator model f₀^{(A)}. The first global model may be initialized as a global null model. Instances of the first global model may be transmitted to each participant system of the set of participant systems.

Given a local model, as a base aggregator model, each participant system may generate a set of predictions on that participant system's data set. Each participant system may then compute gradient and hessian statistics of the prediction. Each participant system may then transmit the gradient and hessian statistics to the aggregator. In some embodiments, the set of participant systems utilize data compression to transmit histogram data (e.g., gradient and hessian statistics) to the aggregator. Once the aggregator receives the gradient and hessian statistics of the set of participant systems, the aggregator may, depending on which participant systems are participating in the model training, merge or fuse the corresponding X, G, and H values via federated quantile sketch fusion processes described herein.

At operation 250, the model component 140 generates a second global model. In some embodiments, the second global model is generated based on a prediction set of the set of participant systems. The prediction set may be generated by the set of participant systems using the set of local models. The prediction set may be merged histogram X, G, and H values received and merged by the aggregator using the federated quantile sketch fusion process. Upon generating the second global model, the model component 140 may cooperate with other components of the aggregator to transmit new local models, based on the second global model, to the set of participant systems.

In some embodiments, once the aggregator receives and merges the X, G, H values and performs aggregated split finding operations, model component 140 may evaluate the first global model based on the split proposal, gradient, and hessian statistics. The model component 140 may perform split finding and build the second global model recursively.

In some instances, upon receiving the X, G, and H values, the model component 140 may find split candidates from a merged histogram. The model component 140 may select split candidates and grow a tree using XGBoost to determine a best split candidate. The model component 140 may then generate the second global model based on the best split candidate. The model component 140 may then cooperate with other components of the aggregator to synchronize the second global model with an updated participant-centric epsilon for each participant system. In such instances, the value component 120 may compute a new set of epsilon values for the participant systems based on the merged or aggregated histogram. Once the model component 140 has synchronized the second global model and the new epsilon values, the aggregator may cause the set of participant systems to generate new predictions based on the second global model or a local version thereof.

In some instances, the aggregator repeats the process of iteratively generating subsequent global models until a stop condition occurs. The stop condition may be a predetermined threshold of rounds, iterations, or models. The stop condition may be generation of an optimized model based on specified model or prediction characteristics or thresholds. In some instances, when a new participant system is added, the aggregator repeats the process of iterative model generation until all of the participant systems, including the new participant system, meet a specified prediction threshold or accuracy threshold.

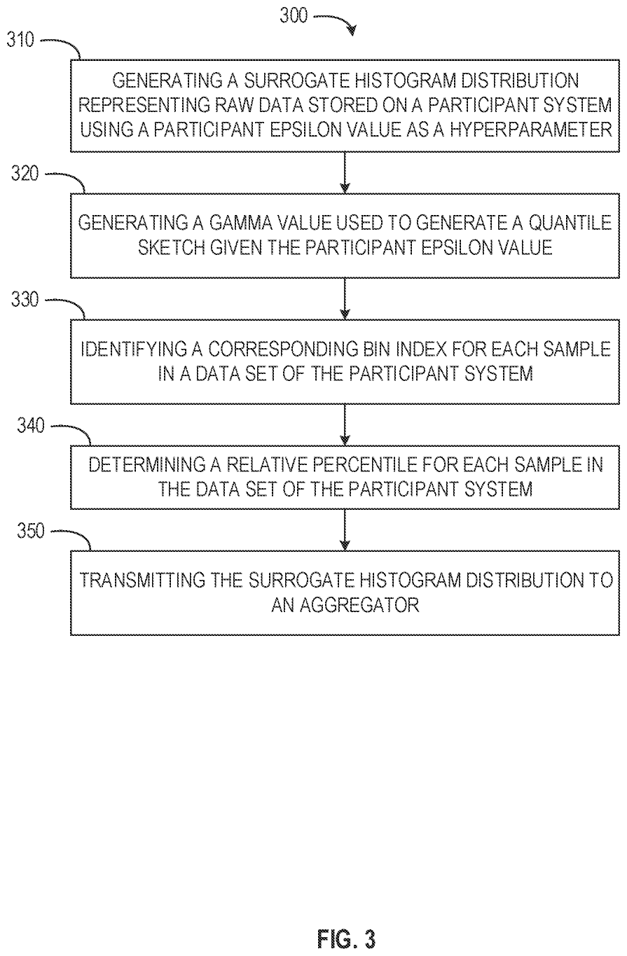

FIG. 3 shows a flow diagram of an embodiment of a computer-implemented method 300 for training models for federated learning. The method 300 may be performed by or within the computing environment 100. In some embodiments, the method 300 comprises or incorporates one or more operations of the method 200. In some instances, operations of the method 300 may be incorporated as part of or sub-operations of the method 200.

In operation 310, the histogram component 150 generates a surrogate histogram distribution. The surrogate histogram distribution may be generated using a participant epsilon value as a hyperparameter to build a local surrogate histogram representation of raw data stored on the participant system. In some instances, the surrogate histogram distribution is generated using a participant epsilon value to define a bin size of the histogram distribution. The surrogate histogram distribution may be generated by each participant system using an implementation of the histogram component 150. In some embodiments, the surrogate histogram distribution, for each participant system, is generated based on the participant epsilon value and the data set of the participant system for which the surrogate histogram distribution is being generated.

In operation 320, the histogram component 150 generates a gamma value used to generate a quantile sketch given the participant epsilon value. The gamma value may be a value for the accuracy range discussed above with respect to operation 220. In some instances, each participant system generates its own gamma value. In some instances, the gamma value is provided to each participant system based on the global epsilon value or the participant epsilon value provided by the aggregator.

In operation 330, the histogram component 150 identifies a corresponding bin index for each sample in the data set of the participant system. In some embodiments, each participant system identifies the bin index in a manner similar to or the same as described above with respect to operation 220.

In operation 340, the histogram component 150 determines a relative percentile for each sample in the data set of the participant system. In some embodiments, the relative percentile of each sample is determined for the samples in the participant system's data set. The relative percentile may be determined in a manner similar to or the same as described above with respect to operation 220.

In operation 350, the histogram component 150 transmits the surrogate histogram distribution to the communication component 130 of the federated learning aggregator. In some embodiments, the histogram component 150 cooperates with a compression component 160 to transmit the surrogate histogram distribution by compressing a payload of the surrogate histogram distribution. The compression component 160 compresses the payload of the surrogate histogram distribution to generate a compressed histogram distribution.

The histogram component 150 then transmits the compressed histogram distribution to the federated learning aggregator.

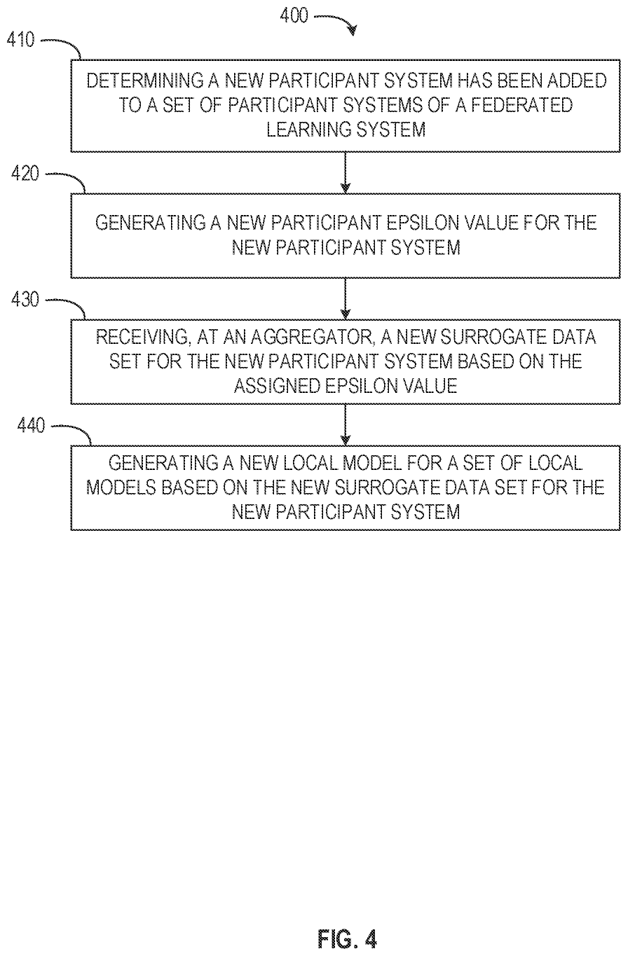

FIG. 4 shows a flow diagram of an embodiment of a computer-implemented method 400 for training models for federated learning. The method 400 may be performed by or within the computing environment 100. In some embodiments, the method 400 comprises or incorporates one or more operations of the method 200. In some instances, operations of the method 400 may be incorporated as part of or sub-operations of the method 200.

In operation 410, the participant component 170 determines a new participant system has been added to the set of participant systems. The participant component 170 may determine the new participant system has been added based on the new participant system accessing the federated learning system 102. In some instances, the new participant system is identified based on a handshake, login, or other introduction of the new participant system to the aggregator. In some instances, the new participant system is identified based on the new participant system initializing a connection between the aggregator and the new participant system.

In operation 420, the value component 120 generates a new participant epsilon value for the new participant system. In some embodiments, the new participant epsilon value is generated independently of the participant system of the set of participant systems. The new participant epsilon value may be generated in a manner similar to or the same as described above with respect to operation 220.

In some instances, the determining or generating of the new participant epsilon value is performed by determining a binning policy by computing the epsilon value for the party independently of data statistics of the other participant systems of the federated learning system 102. In some embodiments, the new participant system is subject to a process similar to that described above with respect to operations 210, 220, and 230. In such instances, the new participant system is subject to a local party quantile sketch process and pre-binning, similar to other participant systems. The aggregator may perform the pre-binning process, performing split value quantile sketches for a given participant system upon registration of the new participant system. The aggregator may then perform quantile sketch for gradient and hessian values for each round or iteration of model generation generated by the aggregator and used by the participant systems.

In some embodiments, generating the new participant epsilon value is performed by performing another iteration of the pre-binning process for the set of participant systems, including the new participant system. The subsequent iteration of the pre-binning process may update local epsilon values for at least a portion of the set of participant systems and cause the set of participant systems to recompute the set of surrogate data sets or histograms.

In some instances, each participant system is queried by the aggregator. The query may obtain from each participant system the relevant statistics for deriving approximation parameters and epsilon values. Each participant system may then have a respective epsilon value distributed to it.

In operation 430, the communication component 130 receives a new surrogate data set for the new participant system. In some embodiments, using the assigned epsilon value, the new participant system generates a local surrogate histogram or surrogate data set. The local surrogate histogram of the new participant system may be generated using the assigned epsilon value as a hyperparameter. The local surrogate histogram or new surrogate data set may act as a representation of a raw data set on the new participant system. Once generated, the new surrogate data set is transmitted to the aggregator to be stored and used in the federated learning process. In some instances, the new participant system performs data compression of the payload of the new surrogate data and transmits a compressed new surrogate data to be received at the communication component 130.

In operation 440, the model component 140 generates a new local model for the set of local models. The new local model may be generated based on the first global model or the second global model. The new local model may also be generated, at least in part, based on the new surrogate data set for the new participant system.

In some embodiments, processing or onboarding of the new participant system, as described above, enables dynamic handling of new parties to the federated learning system 102 in real-time or near real-time. In this way, parties may drop in/drop out from the model training process of the federated learning system 102 with little impact to the federated machine learning process.

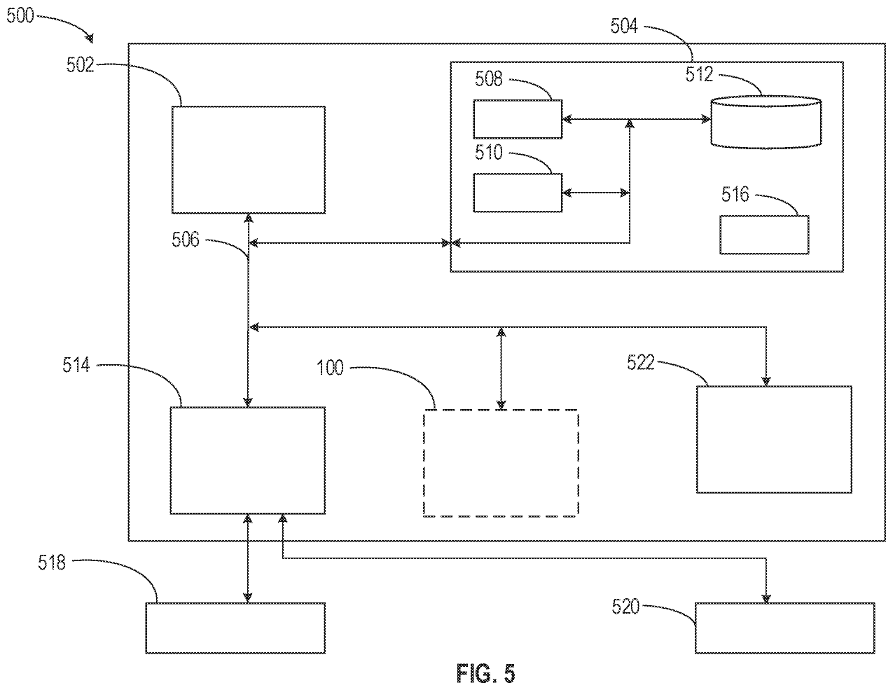

Embodiments of the present disclosure may be implemented together with virtually any type of computer, regardless of the platform is suitable for storing and/or executing program code. FIG. 5 shows, as an example, a computing system 500 (e.g., cloud computing system) suitable for executing program code related to the methods disclosed herein and for training models for federated learning.

The computing system 500 is only one example of a suitable computer system and is not intended to suggest any limitation as to the scope of use or functionality of embodiments of the present disclosure described herein, regardless, whether the computer system 500 is capable of being implemented and/or performing any of the functionality set forth hereinabove. In the computer system 500, there are components, which are operational with numerous other general purpose or special purpose computing system environments or configurations. Examples of well-known computing systems, environments, and/or configurations that may be suitable for use with computer system/server 500 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like. Computer system/server 500 may be described in the general context of computer system-executable instructions, such as program modules, being executed by a computer system 500. Generally, program modules may include routines, programs, objects, components, logic, data structures, and so on that perform particular tasks or implement particular abstract data types. Computer system/server 500 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 500 is shown in the form of a general-purpose computing device. The components of computer system/server 500 may include, but are not limited to, one or more processors 502 (e.g., processing units), a system memory 504 (e.g., a computer-readable storage medium coupled to the one or more processors), and a bus 506 that couple various system components including system memory 504 to the processor 502. Bus 506 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 500 typically includes a variety of computer system readable media. Such media may be any available media that is accessible by computer system/server 500, and it includes both, volatile and non-volatile media, removable and non-removable media.

The system memory 504 may include computer system readable media in the form of volatile memory, such as random-access memory (RAM) 508 and/or cache memory 510. Computer system/server 500 may further include other removable/non-removable, volatile/non-volatile computer system storage media. By way of example only, a storage system 512 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 506 by one or more data media interfaces. As will be further depicted and described below, the system memory 504 may include at least one program product having a set (e.g., at least one) of program modules that are configured to carry out the functions of embodiments of the present disclosure.

The program/utility, having a set (at least one) of program modules 516, may be stored in the system memory 504 by way of example, and not limiting, as well as an operating system, one or more application programs, other program modules, and program data. Program modules may include one or more of the sample component 110, the value component 120, the communication component 130, the model component 140, the histogram component 150, the compression component 160, and the participant component 170, which are illustrated in FIG. 1. Each of the operating systems, one or more application programs, other program modules, and program data or some combination thereof, may include an implementation of a networking environment. Program modules 516 generally carry out the functions and/or methodologies of embodiments of the present disclosure, as described herein.

The computer system/server 500 may also communicate with one or more external devices 518 such as a keyboard, a pointing device, a display 520, etc.; one or more devices that enable a user to interact with computer system/server 500; and/or any devices (e.g., network card, modem, etc.) that enable computer system/server 500 to communicate with one or more other computing devices. Such communication can occur via Input/Output (I/O) interfaces 514. Still yet, computer system/server 500 may communicate with one or more networks such as a local area network (LAN), a general wide area network (WAN), and/or a public network (e.g., the Internet) via network adapter 522. As depicted, network adapter 522 may communicate with the other components of computer system/server 500 via bus 506. It should be understood that, although not shown, other hardware and/or software components could be used in conjunction with computer system/server 500. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with reduced management effort or interaction with a provider of the service. This cloud model may include at least five characteristics, at least three service models, and at least four deployment models.

Service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models may include private cloud, community cloud, public cloud, and hybrid cloud. In private cloud, the cloud infrastructure is operated solely for an organization. It may be managed by the organization or a third party and may exist on-premises or off-premises. In community cloud, the cloud infrastructure is shared by several organizations and supports specific community that has shared concerns (e.g., mission, security requirements, policy, and compliance considerations). It may be managed by the organizations or a third party that may exist on-premises or off-premises. In public cloud, the cloud infrastructure is made available to the general public or a large industry group and is owned by an organization selling cloud services. In hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling modularity, and semantic interoperability. At the heart of cloud computing is an infrastructure that includes a network of interconnected nodes.

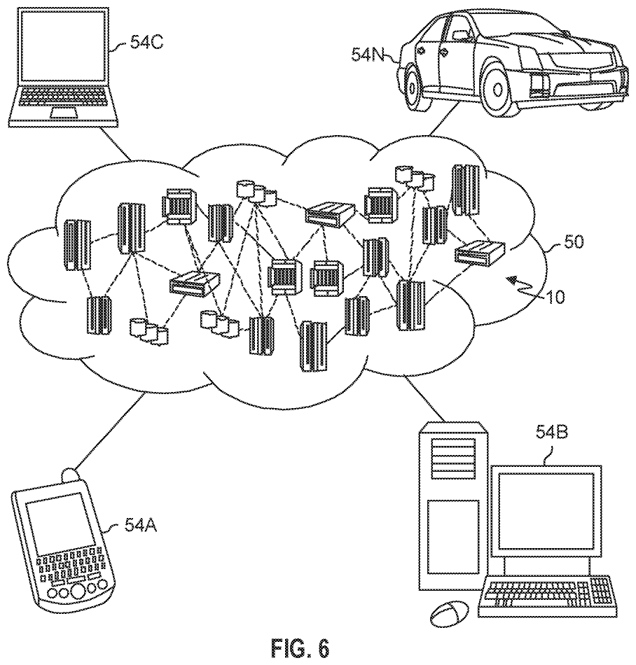

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

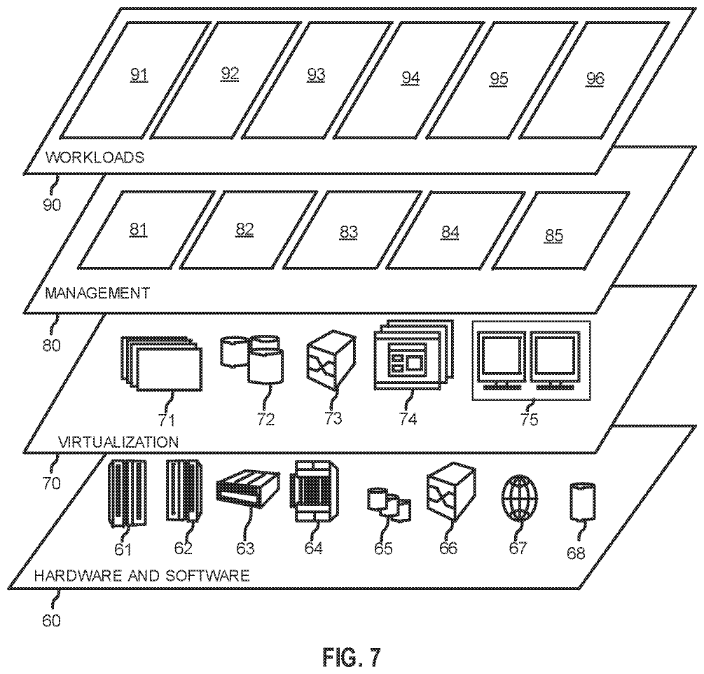

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and federated machine learning processing 96.

Cloud models may include characteristics including on-demand self-service, broad network access, resource pooling, rapid elasticity, and measured service. In on-demand self-service a cloud consumer may unilaterally provision computing capabilities such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In measured service, cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a federated learning aggregator, a set of sample ratios for a set of participant systems, each sample ratio associated with a distinct participant system;
generating a set of participant epsilon values for the set of participant systems, each participant epsilon value being associated with a participant system of the set of participant systems;
receiving a set of surrogate data sets for the set of participant systems, each surrogate data set representing a data set of a participant system;
generating, by the federated learning aggregator, a set of local models, each local model generated based on a first global model; and
generating, by the federated learning aggregator, a second global model based on a prediction set generated by the set of participant systems using the set of local models.

2. The method of claim 1, wherein determining the set of sample ratios further comprises:
determining a number of samples within a data set of each participant system;
determining a total sample size for the set of participant systems; and
generating a sample ratio for each participant system based on the total sample size and the number of samples within a data set of each participant system.

3. The method of claim 2, wherein generating the set of participant epsilon values further comprises:
generating a global epsilon parameter;
for each participant system, generating a participant epsilon value based on the global epsilon parameter and the sample ratio associated with that participant system; and
transmitting the set of participant epsilon values to the set of participant systems, each participant system receiving the participant epsilon value generated based on the sample ratio of that participant system.

4. The method of claim 2, wherein the receiving the set of surrogate data sets further comprises:
generating, by each participant system, a surrogate histogram distribution based on the participant epsilon value and the data set of the participant system; and
transmitting, by each participant system, the surrogate histogram distribution to the federated learning aggregator.

5. The method of claim 4, wherein generating the surrogate histogram distribution further comprises:
generating the surrogate histogram using the participant epsilon value to define a bin size of the histogram distribution;
generating a gamma value used to generate a quantile sketch given the participant epsilon value;
for each sample in the data set of the participant system, identifying a corresponding bin index; and
for each sample in the data set of the participant system, determining a relative percentile.

6. The method of claim 4, wherein transmitting the surrogate histogram distribution further comprises:
compressing a payload of the surrogate histogram distribution to generate a compressed histogram distribution; and
transmitting the compressed histogram distribution to the federated learning aggregator.

7. The method of claim 1, the method further comprising:
determining, by the federated learning aggregator, a new participant system has been added to the set of participant systems;
generating a new participant epsilon value for the new participant system, the new participant epsilon value generated independently of the participant systems of the set of participant systems; and
receiving a new surrogate data set for the new participant system.

8. A system, comprising:
one or more processors; and
a computer-readable storage medium, coupled to the one or more processors, storing program instructions that, when executed by the one or more processors, cause the one or more processors to perform operations comprising:
determining, by a federated learning aggregator, a set of sample ratios for a set of participant systems, each sample ratio associated with a distinct participant system;
generating a set of participant epsilon values for the set of participant systems, each participant epsilon value being associated with a participant system of the set of participant systems;
receiving a set of surrogate data sets for the set of participant systems, each surrogate data set representing a data set of a participant system;
generating, by the federated learning aggregator, a set of local models, each local model generated based on a first global model; and
generating, by the federated learning aggregator, a second global model based on a prediction set generated by the set of participant systems using the set of local models.

9. The system of claim 8, wherein determining the set of sample ratios further comprises:
determining a number of samples within a data set of each participant system;
determining a total sample size for the set of participant systems; and
generating a sample ratio for each participant system based on the total sample size and the number of samples within a dataset of each participant system.

10. The system of claim 9, wherein generating the set of participant epsilon values further comprises:
generating a global epsilon parameter;
for each participant system, generating a participant epsilon value based on the global epsilon parameter and the sample ratio associated with that participant system; and
transmitting the set of participant epsilon values to the set of participant systems, each participant system receiving the participant epsilon value generated based on the sample ratio of that participant system.

11. The system of claim 9, wherein the receiving the set of surrogate data sets further comprises:
generating, by each participant system, a surrogate histogram distribution based on the participant epsilon value and the data set of the participant system; and
transmitting, by each participant system, the surrogate histogram distribution to the federated learning aggregator.

12. The system of claim 11, wherein generating the surrogate histogram distribution further comprises:
generating the surrogate histogram using the participant epsilon value to define a bin size of the histogram distribution;
generating a gamma value used to generate a quantile sketch given the participant epsilon value;
for each sample in the data set of the participant system, identifying a corresponding bin index; and
for each sample in the data set of the participant system, determining a relative percentile.

13. The system of claim 11, wherein transmitting the surrogate histogram distribution further comprises:
compressing a payload of the surrogate histogram distribution to generate a compressed histogram distribution; and
transmitting the compressed histogram distribution to the federated learning aggregator.

14. The system of claim 8, wherein the operations further comprise:
determining, by the federated learning aggregator, a new participant system has been added to the set of participant systems;
generating a new participant epsilon value for the new participant system, the new participant epsilon value generated independently of the participant systems of the set of participant systems; and
receiving a new surrogate data set for the new participant system.

15. A computer program product comprising a computer readable storage medium having program instructions embodied therewith, the program instructions being executable by one or more processors to cause the one or more processors to perform operations comprising:
determining, by a federated learning aggregator, a set of sample ratios for a set of participant systems, each sample ratio associated with a distinct participant system;
generating a set of participant epsilon values for the set of participant systems, each participant epsilon value being associated with a participant system of the set of participant systems;
receiving a set of surrogate data sets for the set of participant systems, each surrogate data set representing a data set of a participant system;
generating, by the federated learning aggregator, a set of local models, each local model generated based on a first global model; and
generating, by the federated learning aggregator, a second global model based on a prediction set generated by the set of participant systems using the set of local models.

16. The computer program product of claim 15, wherein determining the set of sample ratios further comprises:
determining a number of samples within a data set of each participant system;
determining a total sample size for the set of participant systems; and
generating a sample ratio for each participant system based on the total sample size and the number of samples within a data set of each participant system.

17. The computer program product of claim 16, wherein generating the set of participant epsilon values further comprises:
generating a global epsilon parameter;
for each participant system, generating a participant epsilon value based on the global epsilon parameter and the sample ratio associated with that participant system; and
transmitting the set of participant epsilon values to the set of participant systems, each participant system receiving the participant epsilon value generated based on the sample ratio of that participant system.

18. The computer program product of claim 16, wherein the receiving the set of surrogate data sets further comprises:
generating, by each participant system, a surrogate histogram distribution based on the participant epsilon value and the data set of the participant system; and
transmitting, by each participant system, the surrogate histogram distribution to the federated learning aggregator.

19. The computer program product of claim 18, wherein generating the surrogate histogram distribution further comprises:
generating the surrogate histogram using the participant epsilon value to define a bin size of the histogram distribution;
generating a gamma value used to generate a quantile sketch given the participant epsilon value;
for each sample in the data set of the participant system, identifying a corresponding bin index; and
for each sample in the data set of the participant system, determining a relative percentile.

20. The computer program product of claim 15, wherein the operations further comprise:
determining, by the federated learning aggregator, a new participant system has been added to the set of participant systems;
generating a new participant epsilon value for the new participant system, the new participant epsilon value generated independently of the participant systems of the set of participant systems; and
receiving a new surrogate data set for the new participant system.
